(19) United States
(12) Patent Application Publication
(10) Pub. No.: US 2008/0021748 A1
(43) Pub. Date: Jan. 24, 2008

(54) System and Method for Providing Travel-Related Products and Services

(75) Inventors: Brice J. Bay, Greenville, SC (US); Kevin A. Miller, Greenville, SC (US); Michael P. Quattlebaum, Greenville, SC (US); William W. Kellett IV, Greenville, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: 10BEST, INC., Greenville, SC (US)

(21) Appl. No.: 11/738,320

(22) Filed: Apr. 20, 2007

Related U.S. Application Data
(60) Provisional application No. 60/793,417, filed on Apr. 20, 2006.

(51) Int. Cl. G06Q 30/00

(52) U.S. Cl. 705/6; 700/83; 705/1; 705/28

(57) ABSTRACT

The present invention provides a system and method for presenting travel-related products and services to be used by a traveler. A global distribution service maintains records associated with travelers. Each record corresponds to a traveler and contains information corresponding to a destination for that traveler, along with a date or dates corresponding to that destination. The invention receives the record or information contained in the record from the global distribution service for an associated traveler indicating the traveler's destination and corresponding date. Based on the received information, the invention automatically requests travel-related products and services from a number of providers corresponding to the destination and date. The invention then generates a list of the travel-related products and service for purchase by an agent or the traveler for use by the traveler.

### CLAIM OF PRIORITY

The present application claims the benefit of the U.S. provisional application filed on Apr. 20, 2006 by Bay et al. for System for Providing Travel-Related Products and Services (Ser. No. 60/793,417), the entire disclosure of which is incorporated by reference herein.

### FIELD OF THE INVENTION

This invention relates to a system integrated with a global distribution service to provide destination and travel-related information, products, and services specific to a traveler's potential or previously-selected destination or destinations.

### BACKGROUND OF THE INVENTION

In the past, travelers had to contact an airline, hotel, or other travel service provider directly in order to purchase plane tickets, hotel rooms, etc. The creation of travel agencies provided travelers with the ability to contact one entity to purchase airplane tickets, hotel reservations, and other travel necessities. These travel agencies then began to branch out and simultaneously get quotes and options from several airlines and hotel chains to provide travelers with competitive options.

During this time, different airlines collaborated and created companies known as global distribution services (“GDS”). The collaborating airlines then turned over their inventory to the GDS. At that point, one GDS could provide flight inventory and availability with regards to several airlines at one time. Anyone requesting information would no longer be required to directly contact each airline individually. Soon thereafter, hotel chains and other travel service providers began using these GDSs or created comparable services of their own.

Since this time, companies have created systems allowing agents, and eventually the traveler, to search GDS and other inventories online and book desired travel-related products and services, such as airplane tickets and hotel rooms. Examples of websites providing such services to the traveler include www.orbitz.com, www.travelocity.com, and www.priceline.com. When an agent or a traveler selects and purchases a travel-related product or service, the corresponding GDS generates a “passenger-name-record,” or PNR. A PNR contains the entire information of the traveler's transaction including such items as the passenger's name, destination, the name of the service provider, etc. For example, if a traveler purchased a roundtrip plane ticket from Atlanta, Georgia to New York, New York, a PNR would be generated for the trip. The PNR would include the passenger's name, the name of the airline, and other items, such as whether the passenger has requested a kosher meal or a window seat. PNRs are stored and maintained by the GDS supplying the inventory of the travel-related items, to which the PNRs correspond. Other travel-service providers, which can include hotel chains, using services comparable to GDSS, store traveler transactions in records similar to PNRs.

Additional systems have been created to provide travelers, either directly or through a travel agent, with information regarding travel conditions, weather, local restaurants, etc. corresponding to a specific destination. Those and other systems provide travelers or their agents with information regarding attractions and events at specific locations. Recently, systems have been created to allow a traveler or his agent to purchase tickets and admissions in advance to these attractions and events occurring during a traveler's visit to a specific destination. In order to purchase these tickets in advance, the traveler or his agent is required to provide such a system with a destination and time in order to determine which attractions and events are available.

### SUMMARY OF THE INVENTION

The present invention recognizes and addresses the foregoing considerations, and others, of prior art construction and methods. In one aspect, the present invention provides a system and method for presenting travel-related products for use by a traveler where data that identifies a traveler is transmitted to a global distribution service. Based on that data, a record that includes a destination and a corresponding date is accessed at the global distribution service. A list is automatically generated of travel-related products corresponding to the destination and corresponding date from the record.

According to another aspect, the present invention also provides a network of computers including a first computer maintained by a global distribution service that maintains a record corresponding to a traveler. The record includes a destination and a corresponding date. The network also includes a second computer configured to maintain an inventory of travel-related products and services on a memory included in the computer. Additionally, the network includes a third computer operatively connected to the other two computers. The first computer is configured to transmit data that includes a destination and a corresponding date to the third computer. The third computer is configured to automatically request a list of travel-related products and services from the second computer where the list of products and services correspond to the destination and corresponding date.

A further aspect of the present invention provides a system and method for extracting a destination and corresponding date from a record maintained by a global distribution service where that record corresponds to a traveler; for automatically requesting travel-related products and services from a plurality of providers of travel-related products and services, where the request is based on the destination and corresponding date; responsively generating a list of travel-related products and services; and reserving a travel-related product or service for the traveler from the list.

In another aspect, there is provided a record maintained by a global distribution service. The record corresponds to a traveler and contains a destination and corresponding date. A first memory contains an inventory of travel-related products and services. A processor operatively connected to the global distribution service and in communication with the memory is configured to receive the destination and corresponding date of the record from the global distribution service and automatically request a list of travel-related products and services from the inventory based on the destination and corresponding date.

In one aspect, the present invention provides a system and method for generating a list of travel-related products and services corresponding to an input provided by a user, where the input includes at least a destination and a date; purchasing a travel-related product or service from the list, where the product or service corresponds to the destination and date; creating a record maintained by a global distribution service that includes data representative of the purchase of the travel-related product or service that includes the destination and date; extracting the destination and date from the record; and automatically generating another list of travel-related products and services based on the destination and date from the record.

According to another aspect, the present invention also provides an inventory control system and method for managing an inventory of travel-related products offered by a provider for use by a traveler that includes an electronic network, a first processor operatively connected to the network, a memory in communication with the processor and capable of storing data representative of the inventory, and a display operatively connected to the network. The processor is configured to receive data from the provider over the network that's representative of a travel-related product or service, add the data to the memory, transmit the data to the display, receive other data representative of payment information for the purchase of the product or service, create a voucher corresponding to the payment information and the travel-related product or service that contains a validation code, and transmit the voucher to the traveler.

A further aspect of the present invention provides a computer program embodied in a tangible medium that presents travel-related products for use by a traveler. The computer program transmitting data capable of identifying the traveler to a global distribution service, receiving at least a portion of a record maintained by the global distribution service that corresponds to said traveler, where the portion of the record includes a destination and a date, and automatically generating a list of travel-related products and services based on the destination and date.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a system in accordance with an embodiment of the present invention;

FIG. 2 is a flowchart of a method of a system in accordance with an embodiment of the present invention;

FIGS. 3 through 6 show web interface components of a system in accordance with an embodiment of the present invention;

FIG. 7 is a diagrammatic representation of a system in accordance with an embodiment of the present invention;

FIGS. 8 and 9 are flowcharts of a method in accordance with an embodiment of the present invention; and

FIG. 10 illustrates a web interface of a system in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

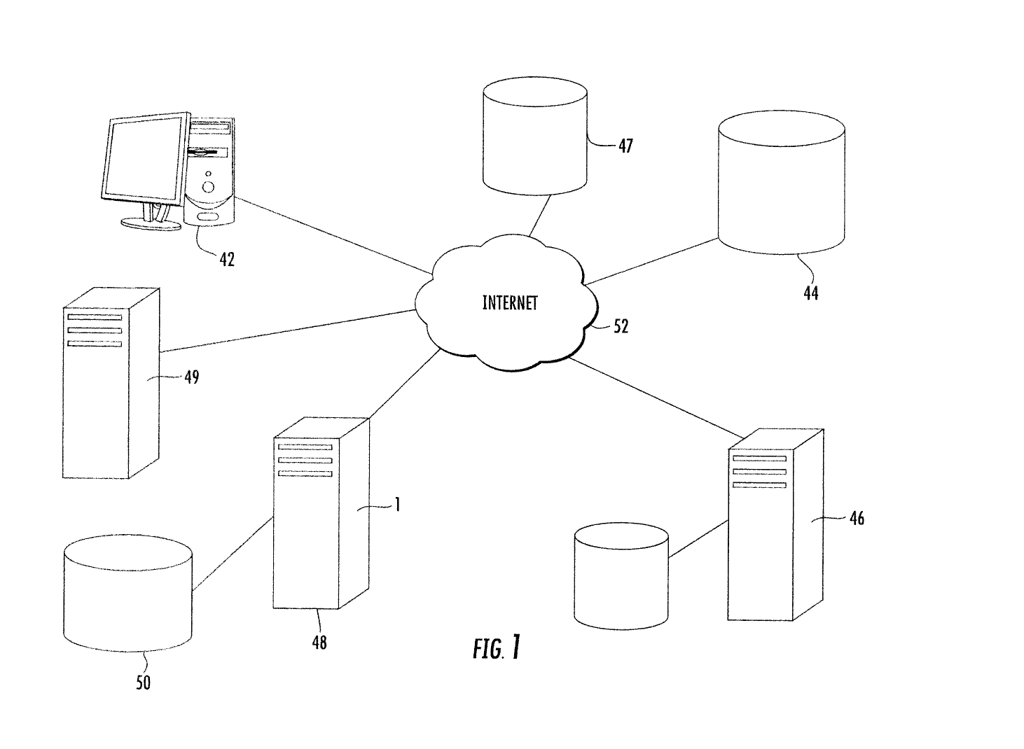

Referring to FIG. 1, a system 1 of the present invention is located on at least one computer 48 which communicates with at least one database 50. It should be understood by those skilled in the art that the information contained in database 50 can be located on a separate computer or can be located on computer 48. System 1 is operatively connected to a global distribution service (“GDS”) 44 and at least one travel partner 46 via a network 52, such as the global computer network known as the Internet. It should be apparent to one skilled in the art that computer 48 can be any of a multiple of various computers or servers capable of sending and receiving information over network 52. One skilled in the art will also recognize that system 1 can be connected to other providers of travel-related services (collectively denoted at 47) and other travel websites (collectively denoted at 49). An agent or traveler can access system 1 through a web browser program running on the user's computer 42. In the current example, system 1 is a web application running on computer 48. It should be understood to one skilled in the art, however, that system 1 can easily be converted into a standalone program that can be accessed over network 52 from user's computer 42 or can be installed directly on user's computer 42.

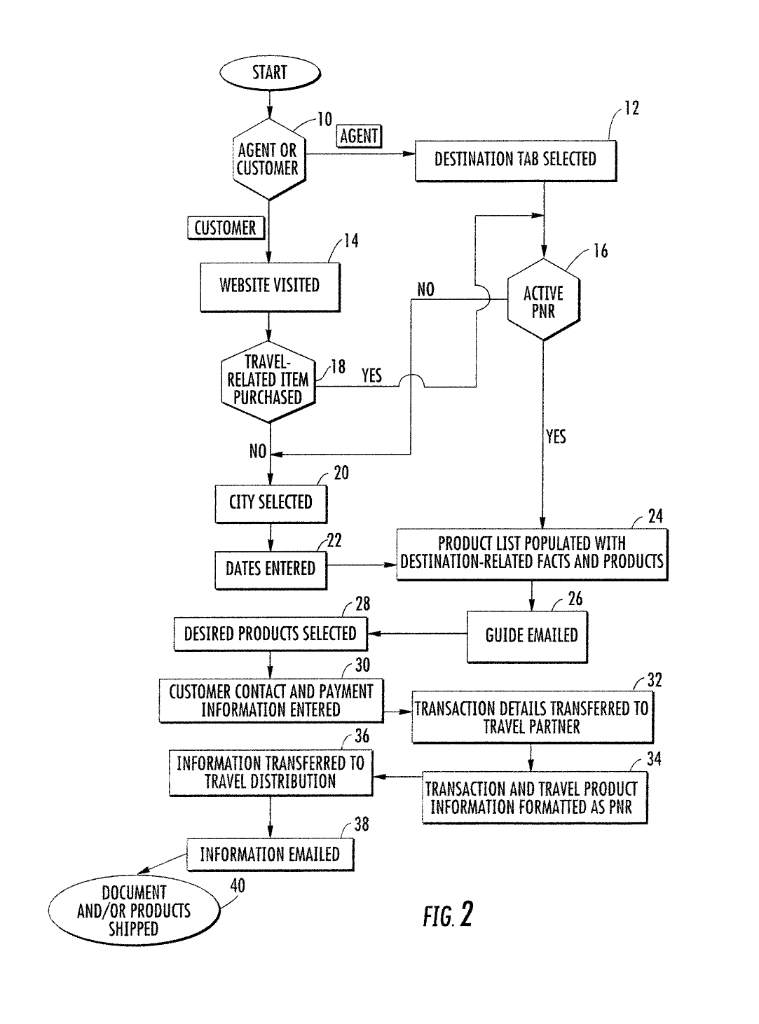

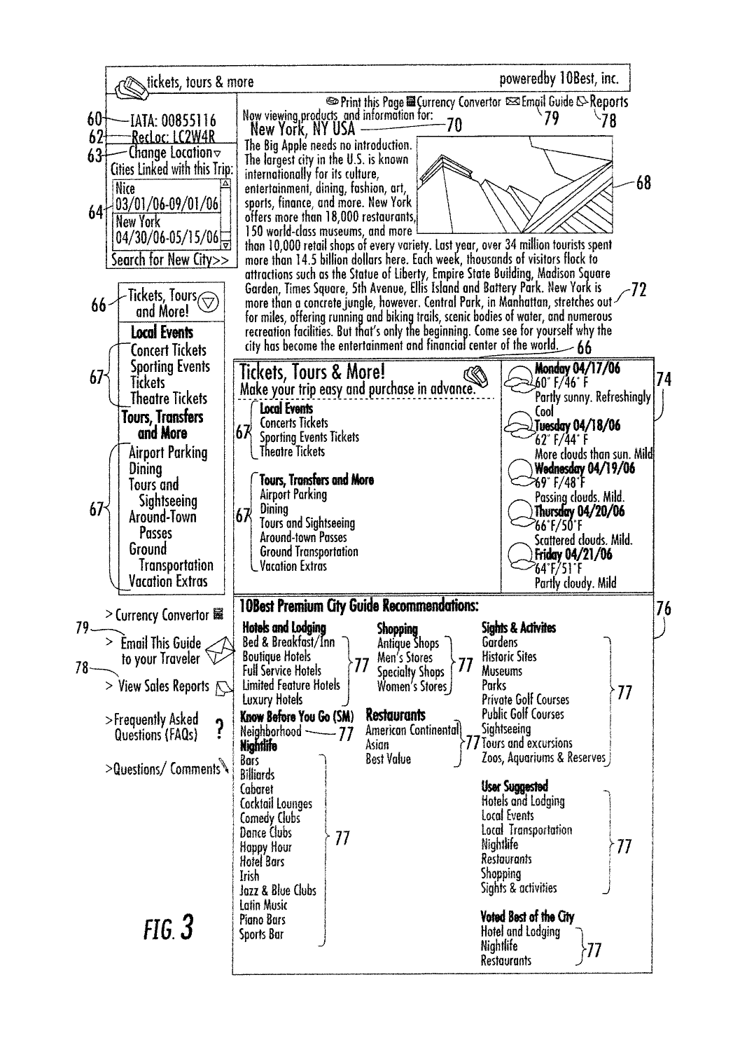

FIG. 2 is a flowchart that schematically illustrates the operation and use of system 1 in accordance with one embodiment of the present invention. The method is described generally here with respect to FIGS. 1 and 2 to aid understanding and in more detail below with respect to FIGS. 3 through 6. Referring to FIGS. 1 and 2, whether the user is an agent or a traveler determines which path is accessed as shown at initial step 10. If the user is an agent, he will generally have a program running on his computer 42 that allows the agent to reserve and order travel-related items for the agent's customers. Most of these agent programs have been converted to web-based applications. Regardless of whether the agent's program is web-based or a standalone application, it will have a section connected to system 1 on computer 48 via network communications. The agent initiates this section by selecting a “destination tab” within the program at step 12.

If the agent has already reserved or purchased a travel-related product or service (such as an airline ticket) for the agent's customer, a “passenger-name-record” (“PNR”) has already been generated by GDS 44 and is active at step 16. As discussed above, this PNR or PNRs include information corresponding to the products or services purchased or reserved for the agent's customer. In this case, the application running on the agent's computer 42 is aware that a PNR is active and transmits this acknowledgment to system 1. It should be understood to one skilled in the art that other products and services may also have been purchased from other providers, such as provider 47, that have created a record similar to the PNR generated by GDS 44. For ease of understanding, it should be understood that discussion of GDS 44 and the related PNRs is meant to include providers 47 and their equivalent records, respectively.

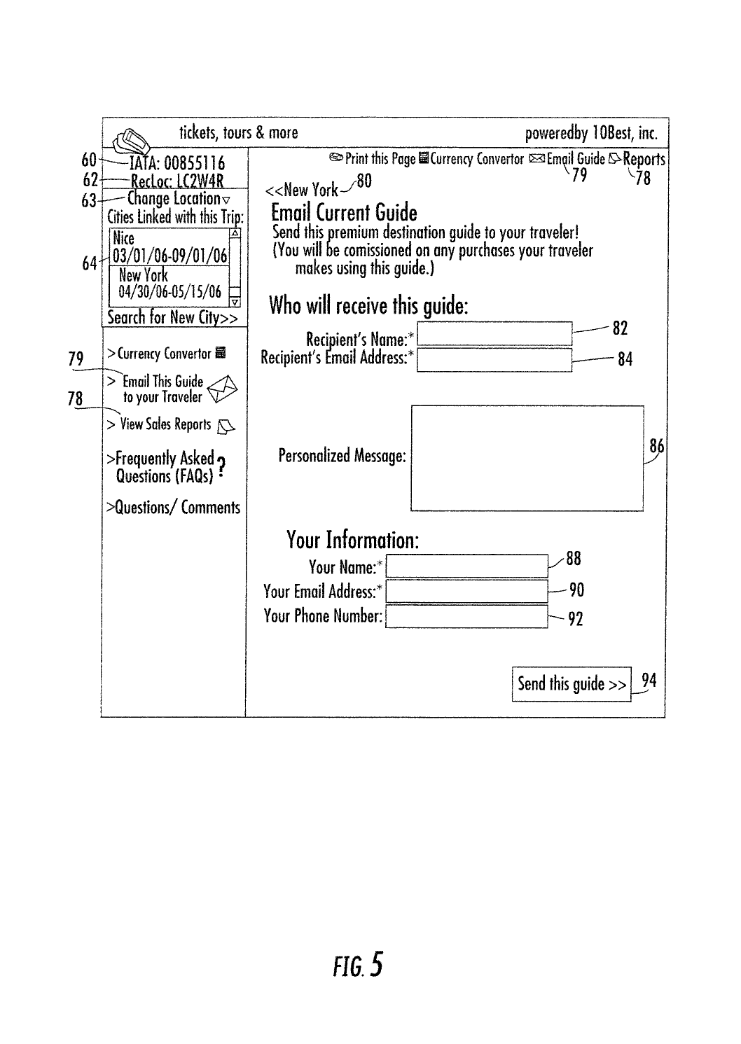

If a PNR is active, process flow continues to step 24, where system 1 requests the active PNR from GDS 44 and extracts the relevant information corresponding to the traveler's destination(s), including the scheduled dates the traveler will visit the extracted destination(s). System 1 retrieves information from database 50 and other travel partners, such as travel partner 46, corresponding to the destination(s) and date(s) extracted from the active PNR. This information can include general facts about the destination(s), maps, travel guides, products, services, etc. A product list is then populated including all the information retrieved from database 50 and travel partners 46. A web interface corresponding to step 24 is depicted by FIG. 3 and will be discussed in detail below. At step 26, the agent has the ability to transmit an interface similar to the one created for the agent at step 24 via an electronic mail message to the traveler. The web interface that allows the agent to email a destination-specific list to the traveler is illustrated by FIG. 5 and will be discussed in detail below.

Returning to step 10, if the user is the traveler herself, the web browser running on the user's computer 42 will access system 1 via a travel-related website at step 14. This website can be provided by website 49, travel partner 46, system 1, or any other entity offering travel-related information. At this point, the traveler may be accessing this website for the first time, may have purchased travel-related items from this website in the past, or may currently be purchasing travel-related items. It should be understood by one skilled in the art that the functionality of system 1 can be incorporated into practically any website. These websites may include the ability to verify a return customer who has purchased travel-related products or services. This ability to remember prior customers may be through the use of cookies, a login prompt, etc. The use of such verification options should be understood to those skilled in the art and are, therefore, not discussed in further detail. In a manner similar to the process described above with respect to the use of system 1 by an agent, the website will also include a section connected to system 1 and directed to additional travel-related products or services.

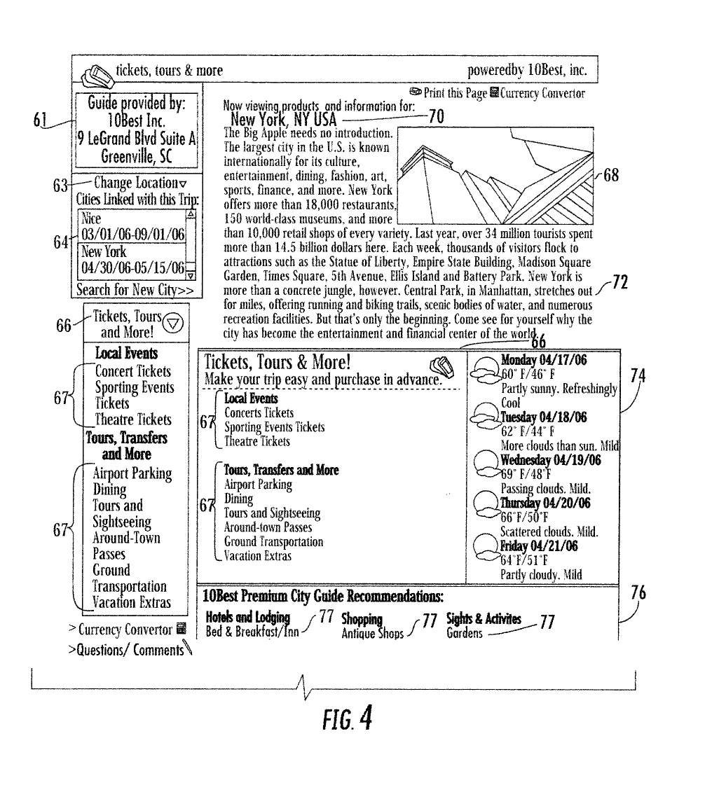

If the traveler purchases a travel-related product or service from the website during the current visit to the website or has purchased an item during a previous visit and her identity has been verified, the application hosting the website will have access to the purchased item's information. When the traveler activates the section of the current website connected to system 1, the application hosting the website determines at step 18 whether the current traveler has already purchased or reserved a travel-related item and transmits this information to system 1. It should be understood by one skilled in the art that activation of the website's section connected by system 1 can be through an HTML form, a hyperlink, a URL redirection, an email, etc. In the same manner as described above with respect to the process followed by the agent, if the traveler has already purchased a travel-related product or service, the information has been transmitted to GDS 44, which has generated a PNR corresponding to the traveler's transaction. Process flow then continues to step 16, where the application hosting the website transmits the acknowledgement that there is an active PNR associated to the current traveler. System 1 requests this PNR from GDS 44 and extracts the relevant information corresponding to the traveler's destination(s), including the planned travel dates. As described above, system 1 retrieves information from database 50 and other travel partners, such as travel partner 46, corresponding to the destination(s) and date(s) extracted from the active PNR. A product list is populated including all the retrieved information, products, services, etc. at step 24. The web interface available to the traveler displaying this list is illustrated by FIG. 4 and will be discussed in greater detail below.

Alternatively, the web interface described immediately above can also be presented in the form of an email transmitted directly to the traveler either from the agent or, in some cases, directly from system 1 as described above with reference to step 26. It should be understood by one skilled in the art that the web interface as described above, and which will be described in more detail below with respect to FIG. 4, can be transmitted via an electronic mail message without deviating from the form, functionality, and/or operation of the interface. This email interface includes the list populated at step 24 by the agent or system 1. If the web interface is transmitted directly to the traveler in the form of an electronic mail message, the traveler omits steps 10 through 26 and proceeds directly to step 28 discussed below.

Referring again to FIGS. 1 and 2, step 20 is reached if there is not an active PNR related to the traveler created either by the traveler or the traveler's agent as discussed above. Using the web interface of the agent's application or the travel-related website visited by the traveler, the traveler or agent selects a destination. At step 22, the traveler or agent selects the dates during which the traveler is scheduled to visit the destination selected at step 20. Upon completion, system 1 uses the selected date(s) and destination to create a list of additional travel-related information, products, services, etc. at step 24 retrieved from database 50 and travel partners, such as travel partner 46. As described above, examples of the populated list included in web interfaces are illustrated by FIGS. 3 and 4 related to the web interface used by the agent and the traveler, respectively.

At step 26, the agent (or the traveler in certain instances) has the option of emailing an interface that includes the list populated with travel-related information, products, services, etc. specific to the traveler's destination(s) as discussed above. The agent emails the destination-specific list using the interface illustrated by FIG. 5 discussed below.

At step 28, destination-specific products and services can be selected directly by the traveler or indirectly for the traveler by the agent using any of the interfaces that include the populated lists discussed above. The traveler's contact and payment information is entered into the web interface to reserve or purchase the travel-related items, as indicated at step 30. The details related to this transaction are transmitted by system 1 to travel partner 46 responsible for the purchased travel-related item. System 1 then formats the transaction details as a PNR at step 34 and transmits the PNR to GDS 44 at step 36. This PNR includes information corresponding to the purchased item and the traveler. GDS 44 can store this PNR or add the information contained therein to the traveler's active PNR if desired. At step 38, the transaction details are emailed to the agent and/or the traveler depending on the traveler's preferences. Similarly, at step 40, the documents and/or products corresponding to the travel-related items purchased for or by the traveler are shipped to the agent and/or traveler (again depending on the traveler's preferences). It should be understood that shipping can include transmission of an electronic mail message for items whose purchase are only evidenced by documents or confirmation numbers.

FIG. 3 illustrates an exemplary web interface of the agent's application connected to system 1 as described above. As shown, an agent identification section 60 displays information corresponding to the current agent. A record locator identification section 62 displays a record locator, which corresponds to and identifies the active or open PNR. A drop-down box 63 lists other destinations available to the agent. Drop-down boxes and their operation should be understood to those skilled in the art. Selecting drop-down box 63 displays a list of additional destinations that the agent can select to view additional travel-related information, products, services, etc. related to those destinations. A selection box 64 displays all destinations related to the record locator listed in section 62 and the active PNR. Two quick link sections (collectively denoted at 66) display categories of additional travel-related products and services that can be purchased for the selected destination. Sections 66 include multiple hyperlinks (collectively denoted at 67) that each correspond to a category of travel-related products and services that can be purchased related to the chosen destination. Hyperlinks and their operation should be understood by those skilled in the art and, therefore, are not discussed in more detail.

A label 70 identifies the currently-selected destination and a picture section 68 displays a photograph related to the destination. A text section 72 displays general information related to the selected destination. A weather section 74 displays current weather conditions for the selected destination. In another embodiment, section 74 alternatively or in addition displays weather conditions expected during the dates when the traveler will visit the selected destination as indicated in the related PNR.

A city guide section 76 displays a list of categories related to travel information of the selected destination. City guide section 76 includes various categories such as hotels and lodging, shopping, sights and activities, nightlife, restaurants, etc. Each category contains travel information useful to a traveler expected to visit the selected destination. Numerous hyperlinks (collectively denoted at 77) are listed below each category in city guide section 76. Hyperlinks 77 correspond to additional categories under the main categories discussed above.

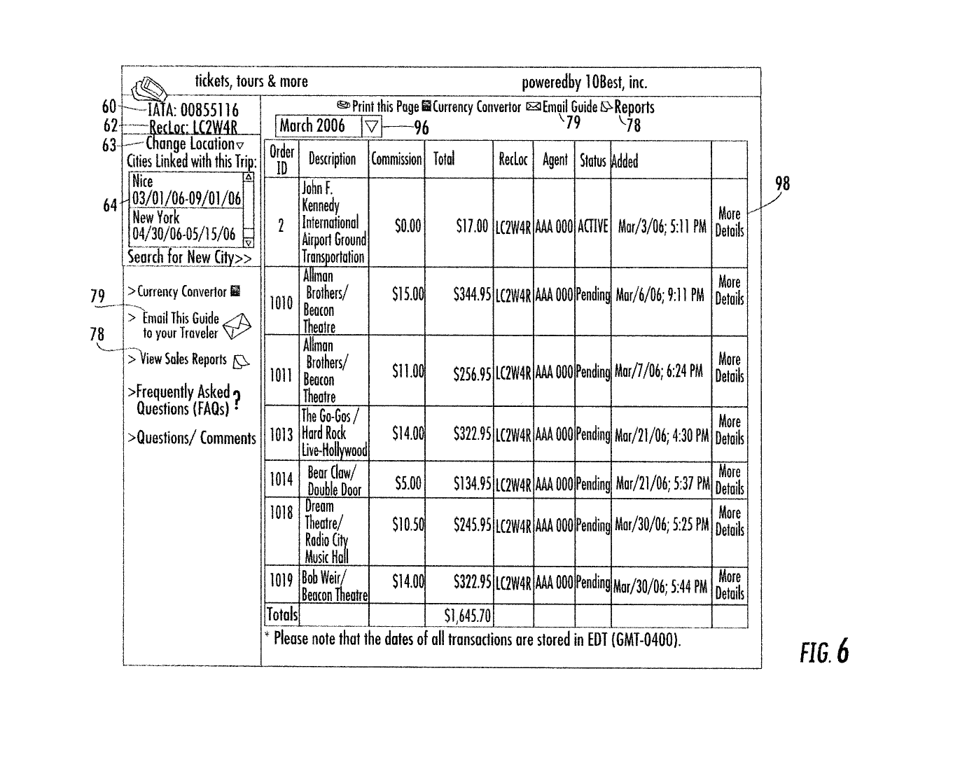

Activation of either of two report hyperlinks (collectively denoted at 78) displays an additional web interface illustrated by FIG. 6 (discussed in more detail below). Two email guide hyperlinks (collectively denoted at 79) provide the agent with the ability to email the guide for the current destination to the traveler. Activation of email guide hyperlinks 79 displays an additional web interface illustrated by FIG. 5 (discussed in more detail below). This web interface may also include a currency converter that allows the user to convert of currency values to a number of different foreign currencies and vice versa.

Selecting a different destination from the list displayed in selection box 64 will reload the web interface. When the web interface reloads, system 1 retrieves travel-related information, products, and services corresponding to the newly selected destination from database 50 and travel partners, such as travel partner 46, in a manner identical to that described above with respect to step 24 (FIG. 2).

FIG. 4 illustrates a web interface to be used by the traveler that can be integrated with a travel-related website, emailed to the traveler, or provided as a standalone application. A section 61 displays information corresponding to the manner in which the traveler received the interface. This can include the agent or agency that emailed the interface to the traveler or the website the traveler visited that provides a component connected to system 1, as described above. The remaining features and their corresponding functions indicated by numerals 63 through 77 in FIG. 4 are identical to the corresponding features described above with respect to FIG. 3.

Referring to FIGS. 3 and 4, the agent or traveler can examine information related to local restaurants, comedy clubs, theatres, etc. located in or near the selected destination by choosing the corresponding hyperlink from among hyperlinks 77. Activating any one of hyperlinks 77 transfers the agent or the traveler to a web interface that may be otherwise identical but which has replaced section 76 with other categories and detailed information corresponding to the agent or traveler's hyperlink selection. For example, if the agent or traveler selects the “Asian” hyperlink under the “Restaurant” category, the agent or traveler would be directed to an otherwise similar interface listing available restaurants serving Asian cuisine in or near the selected destination.

As described above, sections 66 list travel-related products and services related to the specific destination that can be purchased for or by the traveler. For examples, sections 66 may include items such as concert tickets, sporting events tickets, airport parking and shuttle passes, and other items. These items are available for purchase from various travel partners, such as travel partner 46. When the agent or traveler selects any one of the hyperlinks 67, system 1 connects to and retrieves the corresponding product information from each travel partner (e.g., 46) that provides a product or service matching the agent or traveler's selection and the dates for which the traveler will visit the selected destination. For example, a particular musical group may be performing in the destination on a night which the PNR indicates the traveler will be in town. That concert may show up as an available option for ticket purchase if “concert tickets” is selected. Other concerts, such as concerts for cities not listed in the PNR or for destination city concerts on dates not listed in the PNR, are preferably not displayed. The agent or traveler is then able to select from the list of available products or services matching the agent or traveler's selection.

Once the agent or traveler selects a specific product or service, a form (not shown) within the web interface is provided to allow the agent or traveler to purchase or reserve the travel-related item. The agent or traveler then purchases or reserves the item by entering the traveler's contact and payment information into the form. System 1 (FIG. 1) processes the request as described above with respect to steps 32 through 40 of FIG. 2. The use of forms and web interfaces to input and transmit product and payment information from one system to another using a network, such as the internet, facilitating the purchase of items should be understood to one skilled in the art. The traveler uses the items or documents sent to him to gain admission to or make use of the purchased event, service, or product.

FIG. 5 illustrates an exemplary web interface used by the agent to send the interface including the populated list described above with reference to steps 24 and 26 of FIG. 2 as an electronic mail message. Referring to FIG. 5, features indicated by numbers 60 through 79, as well as their corresponding functions, are identical to the corresponding features described with respect to FIG. 3. The web interface illustrated in FIG. 5 contains a form that includes the following elements: a label 80, a recipient textbox 82, a recipient email textbox 84, a comment box 86, an agent textbox 88, an agent email textbox 90, an agent phone textbox 92, and a submit “button” 94.

Label 80 identifies the destination corresponding to the populated list to be included in the interface transmitted in the electronic mail message. The agent enters the traveler's name in recipient textbox 82 and the traveler's email address in recipient email textbox 84. The agent can enter any additional comments, instructions, or information in comment box 86 to be included in the electronic mail message to be sent to the traveler. The agent enters his or her name in agent textbox 88, his or her email address in agent email textbox 90, and optionally his or her telephone number in agent phone textbox 92. When the agent presses (i.e., clicks on) submit button 94, the web interface containing the populated list related to the destination listed in selection box 64 and label 80 is transmitted in an electronic mail message to the email address listed in recipient email textbox 84. The electronic mail message is addressed to the traveler's name listed in recipient textbox 82 and is sent from the email address listed in agent email textbox 90 of the agent listed in agent textbox 88. The additional information listed in textboxes 86 and 92 are optionally included in the electronic mail message. The traveler can use the emailed web interface to view selections and make purchases as described above.

FIG. 6 illustrates the web interface used by the agent to track travel-related items purchased by the agent for travelers. A report box 98 displays a list of all travel-related items purchased by the agent during a certain time period. This list includes details related to each purchased item, such as a description, total amount, the corresponding record locator (PNR), the date purchased, etc. The agent can alter the time period of the related items displayed in report box 98 by selecting an alternate time period from a time dropdown box 96. Report box 98 will then reflect the travel-related items purchased by the agent corresponding to the new time period selected from dropdown box 96.

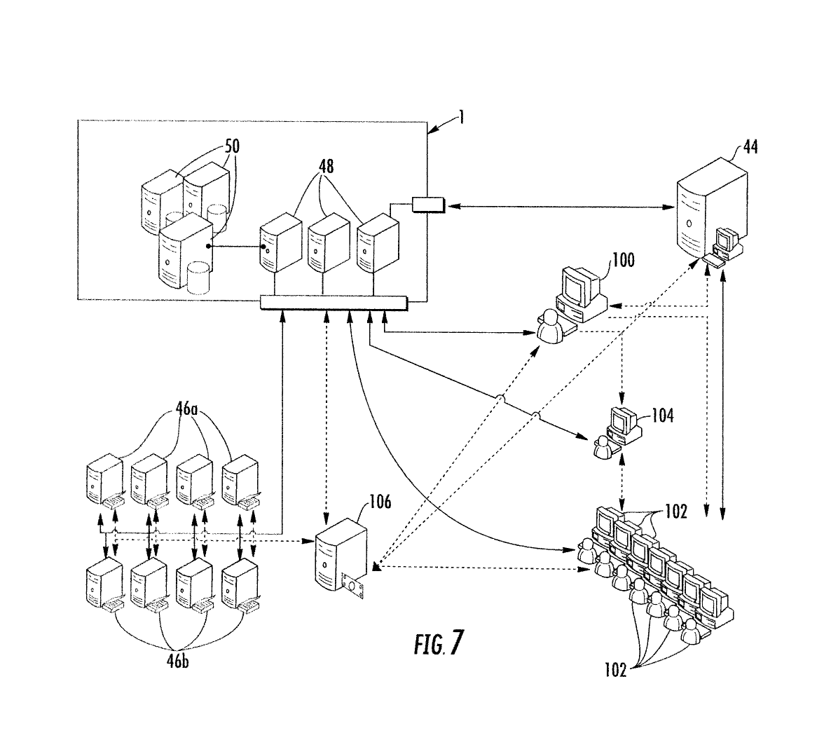

In another embodiment shown in FIG. 7, system 1 includes at least one application server 48 connected to at least one database server 50. System 1 is operatively connected to (e.g., in communication with over a network) GDS 44 and at least one travel partner 46. System 1 and GDS 44 are operatively connected to a number of travel agents represented by agent 100. System 1, GDS 44, and agent 100 are operatively connected to at least one distribution partner 102. Distribution partners 102, along with system 1 and agent 100, are operatively connected to a number of users represented by user 104. Optionally, at least one financial intermediary 106 is operatively connected to system 1, GDS 44, travel partners 46, agent 100, and distribution partners 102.

In operation, agent 100 reviews travel-related inventory, such as airline seats and hotel rooms, provided by GDS 44 or distribution partners 102 using a website or other electronic means, such as a software program located on the agent's computer. For ease of understanding, such a website or software program used by agent 100 will be referred to as an “agent program” and is operatively connected to system 1, GDS 44, distribution partners 102, or any combination thereof. Similar to other embodiments, GDS 44 is a global distribution service that manages inventory for a number of different travel product and service providers, such as a conglomerate of airline partners. Distribution partners 102 may include providers and/or aggregators of various other travel-related products and services, additional providers associated with GDS 44 (and/or other global distribution partners), or even other global distribution partners themselves. For example, distribution partners 102 may include a hotel chain, a venue that provides tickets to various concerts it hosts, or an entity that provides a collection of information representative of other travel-related products, such as a number of hotel chains, additional airlines, or car rental agencies. The agent program retrieves this travel-related inventory from GDS 44 and/or distribution partners 102 via system 1. An aggregator of travel-related products and services is an entity that gathers information regarding the travel-related products and services from a number of providers, each offering one or more travel-related products and services, or from other aggregators.

Travel partners 46 include entities that provide additional travel-related information, products, and services, including information about and tickets to attractions, dining, and events of various destinations. Likewise, database servers 50 contain additional data representative of travel-related information, products, and services offered by other entities, such as local tour guides. The agent program supplies this information from database servers 50 and travel partners 46 to agent 100 via system 1. For example, agent 100 inputs a destination and a date into the agent program, which retrieves available products, services, and information specific to the destination and travel dates from GDS 44, distribution partners 102, database servers 50, and travel partners 46. Travel partners 46a provide data to the agent program related to travel services and products, such as concert tickets, city tours, hotels, etc., specific to the destination and travel dates, while travel partners 46b provide data to the agent program related to weather conditions, popular attractions, historical monuments, etc., specific to the destination and travel dates. Although the majority of data returned to the agent program will include a list of both products and services, as well as non-purchasable information related to the destination and travel dates, these items are referred to herein as “travel-related products” or “product” for simplicity. Data corresponding to these travel-related products provided by system 1, GDS 44, distribution partners 102, and travel partners 46 is generally stored on a computer's memory and most likely arranged as a database or catalog of information.

Agent 100 selects and books one or more travel-related products for user 104 from the list created by the agent program. The data related to the selected product(s) is transmitted by the agent program to GDS 44, which formats and stores the information as a PNR (or an update of an existing PNR). The agent program extracts relevant travel information, such as the destination and travel dates, from the active PNR. The agent program then solicits and retrieves additional travel-related products from database servers 50 and travel partners 46 corresponding to the extracted information. These options are presented by the agent program to agent 100, who may select and book one or more of the options for user 104. If so, data related to the purchased product is transmitted to GDS 44, which adds the data to the active PNR.

When the agent program extracts relevant travel information from the active PNR, it also preferably generates an email to user 104. The email may contain additional travel-related products received from database servers 50 or travel partners 46 corresponding to the user's destination and travel dates. Alternatively, the email may contain a link to a website maintained by system 1, agent 100, or distribution partners 102 that, when visited, displays information about the additional travel-related products specific to the user's destination and travel dates. User 104 may then select and purchase one or more of these travel-related products from the email or website. Data representative of any purchased products is transmitted by system 1 to GDS 44, which formats and adds the data to the user's active PNR. At a later time, system 1 emails or sends the purchased product or confirmation of the purchased product to user 104.

If there are no active PNRs associated with user 104 at the time he visits a website maintained by system 1, agent 100, or distribution partners 102, the user will be able to review travel-related products provided by GDS 44, agent 100, distribution partners 102, database servers 50, and travel partners 46. If user 104 purchases a travel-related product, data relevant thereto is transmitted to GDS 44, which formats and stores the information as a PNR. Similar to above, an email containing additional travel-related products specific to the user's destination and travel dates as contained in the PNR is then sent to user 104. Alternatively, the email may include a link back to the relevant website, which, when visited, provides user 104 with a list of additional travel-related products. Information related to any additional products purchased by user 104 is added to the user's active PNR. Any financial transactions involved in the above process may be handled by system 1 or by optional financial intermediaries 106.

System 1 also includes an application programming interface (“API”), which gives websites, programs, and other systems direct access to the information provided by system 1. In other words, the API allows outside systems to transmit and receive data to and from system 1 without using the websites or programs provided by system 1 but by using the functions and structures defined by the API instead. Agent 100, distribution partners 102, and travel partners 46 communicate with system 1 using the functionality provided by this API. The API offered by system 1 makes use of extensible markup language (“XML”) methods and schema to transmit and receive data between system 1 and any other system accessing the data provided by system 1. APIs, as well as XML and its syntax, should be understood by those of ordinary skill in the art.

As an example of the above, a hotel chain operator provides customers with the ability to search availability of its hotel rooms by using its website. A customer uses the website to reserve and book a hotel room for a specific destination and date. System 1's API allows the hotel chain operator to access all the travel-related products managed by system 1 directly, so that when the customer reserves and books a hotel room for a specific destination and date, other travel-related products offered by system 1, agent 100, GDS 44, travel partners 46, and distribution partners 102 are presented to the customer. Importantly, these options are presented to the customer without the customer leaving the hotel chain's website. Because of the direct connection between the hotel chain's website and system 1 via its API, the hotel chain may offer and sell a vast amount of additional travel-related products to its customers with minimal inconvenience. Additionally, other aggregators of travel-related products, such as a website offering a varying range of items including airline tickets, hotel rooms, and car rentals, increases the amount of products it offers by using the API of system 1.

Application servers 48 also preferably maintain an additional website commonly referred to as a “backend system.” Backend systems should be understood by one of ordinary skill in the art, and it should be appreciated that such a backend system does not have to be available only as a website but may be a standalone program. One function of this backend system is to provide travel partners 46 with the ability to transmit data related to their travel-related products to system 1. It should be understood that travel partners 46 may also provide this data to system 1 via the functionality of the API. System 1 stores the data in database servers 50.

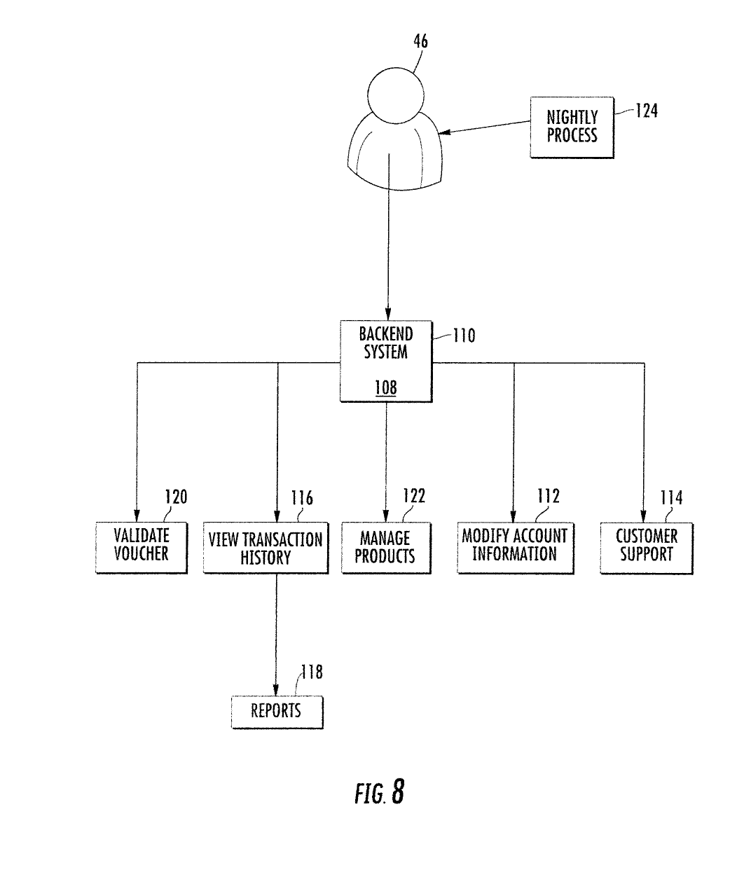

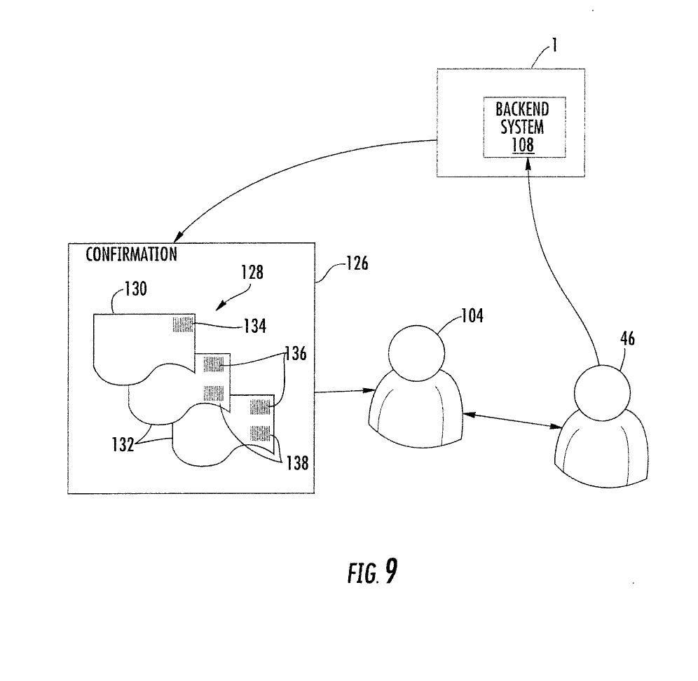

Travel partners 46 may include providers of travel-related products that do not keep an electronic inventory of their products, that do not have a realistic limit to their inventory, or that do not have access to a computer and/or a method of access to system 1. As an example, companies providing city tours may not keep an electronic version of their inventory, do not typically exhaust their supply of inventory in most situations, nor might they have electronic access to system 1. Another function of the backend system described above is not only to give providers such as these the ability to enter data representative of their travel-related products into system 1, but to use system 1 as their own inventory control system. In reference to FIGS. 8 and 9 and continuing with the example above, travel partner 46, such as a provider of city tours, accesses backend system 108 at 110, where the provider logs into the system with a username and password. Travel partner 46 can modify its account information at 112 or contact customer support at 114. Additionally, travel partner 46 may view its transaction history at 116 and print, view, or download reports at 118. In another embodiment with reference to FIG. 9, travel partner 46 may validate vouchers at 120 as described below.

As indicated at 122, travel partner 46 enters data into backend system 108 representative of the travel-related product or products that it offers. In the case of a city tour, for example, this data may include, among other information, the price of the tours, the times of available tours, any family or multiple ticket discounts, and the fact that tour availability is unlimited. This data is stored in database servers 50 maintained by system 1 and made available to all systems accessing system 1 as described above. Travel partner 46 may also modify and manage previously-entered data and products at 122.

Alternatively, if the city tour provider does not have electronic access to system 1, the provider contacts a representative of system 1 by any suitable means, including by telephone. The provider gives the same information to the representative who enters the data related to the provider's product(s) into backend system 108 of system 1.

Once this data is entered into system 1, it may be viewed and purchased by agent 100 and user 104 via the websites, programs, and processes described above. Additionally, during a nightly process at 124, system 1 transmits data to travel partner 46 corresponding to any travel-related products offered by the partner that are sold during that day. In the example of the city tour provider, the transmission may include the number of tickets sold, each purchaser's name, the date of the purchased tour, and its price. As noted above, travel partner 46 may review historical data related to products sold at 116 and can review, print, and/or download corresponding reports at 118. As described above, system 1 sends a confirmation to user 104 either directly or via agent 100 in certain circumstances when a travel-related product is purchased for the user.

FIG. 9 illustrates a confirmation 126 transmitted by system 1 in accordance with another embodiment of the present invention. Confirmation 126 includes a voucher 128 containing a voucher summary page 130. Voucher 128 may also include a number of additional voucher pages 132. Voucher summary page 130 may include a summary barcode 134 and other information, such as the price paid for the product, the date on which product must be used, and the number of participants. Summary barcode 134 includes an identification number that travel partner 46 can use to electronically retrieve data related to voucher 128 from system 1. Alternatively, all relevant data is preferably stored in summary barcode 134. Voucher pages 132 serve as the admission ticket(s) for user 106 and any companions to the associated travel-related product.

When sent to user 104 or agent 100, confirmation 126 may be included in the body of an email, as an attachment to an email, or viewed on a website from a link included in an email. It should be understood that a number of alternative methods may be used for providing confirmation 126 to user 104, such as postal mail, without departing from the spirit and scope of the present invention. In this embodiment, confirmation 126 includes voucher 128 when agent 100 or user 104 purchases a travel-related product offered by travel partner 46 who uses system 1 to manage its inventory, such as the provider of city tours described above. In this case, system 1 handles management and creation of voucher 128 used by such a provider.

In operation, user 104 receives voucher 128 and retains it for admission to the purchased travel-related product. User 104 presents voucher page(s) 132 to travel partner 46 who offers the travel-related product to which the voucher corresponds. Travel partner 46 retains the voucher pages and provides the purchased travel-related product to user 104. As set forth above, this travel-related product may be any travel item, including a guided tour, admission to an airport lounge, or rental of vacation equipment. Travel partner 46 may also scan voucher barcode 134 to acquire information about user 104 and/or voucher 128. If additional purchasers are traveling with user 104, each purchaser presents a separate voucher page 132. Travel partner 46 uses barcodes 136 to confirm that voucher 128 and any additional voucher pages 132 are authentic.

In order to ensure that travel partner 46 is paid the corresponding fee or commission for sale of its travel-related product, the partner uses backend system 108 of system 1. Travel partner 46 validates voucher 128 (at 120 of FIG. 8) by entering the identification numbers of validation barcodes 138 or by scanning the barcodes into backend system 108. Alternatively, travel partner 46 returns the actual voucher 128 to the operators of system 1, via postal mail or any other acceptable method, who handle validation of the voucher. Once the operator of system 1 processes the used voucher, payment is made to travel partner 46, deducting any commission due to the operator of system 1, a travel agent, or other payee.

Referring again to FIG. 8, travel partner 46 uses backend system 108 to view transaction history at 116 and corresponding reports at 118. This allows travel partner 46 to review all travel-related products that the partner has sold, that a customer has consumed, for which corresponding vouchers have been validated, and for which the partner has or will be compensated.

In another embodiment, user 104 accesses the products managed by system 1 using another entry point, such as a system maintained by agent 100, GDS 44, travel partners 46, or distribution partners 102. These systems can use any available means to present the travel-related products managed by system 1 to user 104, such use a website or portions of a website maintained by system 1 or a website that communicates with system 1 through the functionality of its API. User 104 visits such a website or is directed to the website via agent 100, GDS 44, travel partners 46, or distribution partners 102 either before or after purchasing a travel-related product.

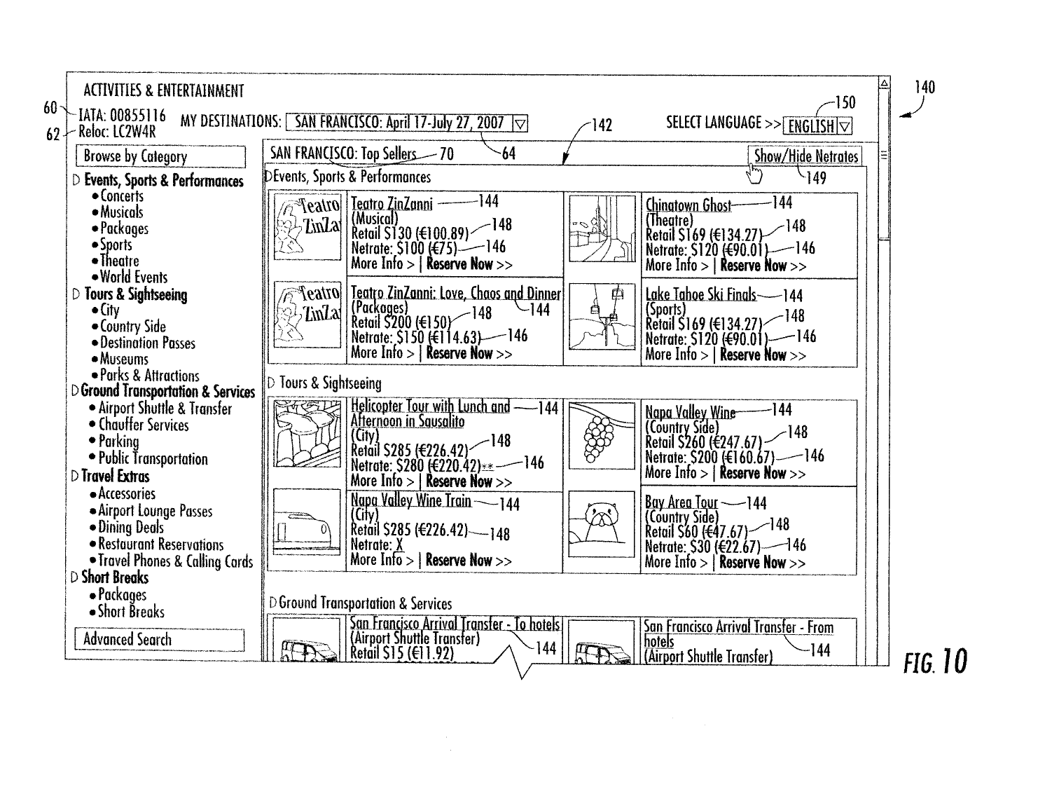

FIG. 10 illustrates a website 140 used by agent 100 in accordance with another embodiment of the present invention that immediately provides any sale's commission to the agent. Website 140 includes a list 142 of travel-related products 144, which can include almost any item from an airline ticket to a day pass for an airport lounge to a guided safari tour. Each travel-related product is associated with a price 146 and a suggested price 148. Website 140 also includes a toggle button 149, a language selector 150, and a currency selector.

In operation, agent 100 reviews list 142 on website 140 in order to reserve or purchase travel-related products 144 for user 104. Suggested price 148 indicates the price suggested by system 1 that agent 100 should charge user 104 for the related product. Price 146 is the price system 1 charges agent 100 for the related product's sale, which is calculated by deducting the agent's commission on the product from suggested price 148. As a result, agent 100 immediately collects any commissionable amounts for the product. For example, a tour of New York City may cost fifteen dollars ($15) and include a sale's commission of five dollars ($5) for a total amount of twenty dollars ($20). Website 140 displays price 146 for the tour as fifteen dollars ($15), whereas suggested price 148 for the tour is displayed as twenty dollars ($20). If agent 100 charges and collects twenty dollars ($20) for the tour from user 104, he automatically retains five dollars ($5) as the sale's commission and tenders the remaining fifteen dollars ($15) to system 1. This can be accomplished by any adequate means, including the transfer of funds electronically. This “net sales” process allows agent 100 to collect its commission faster and also to collect a greater amount of commissions if items are sold above suggested price 148 thereby maximizing the agent's profit. Activation of toggle button 149 removes price 146, so that agent 106 may show website 140 to user 104 without disclosing any commission amount the agent will receive for the sale of each travel-related product 144.

Information and prices on website 140 are displayed in the default language and currency for agent 100, but may be changed using language selector 150 and a similar currency selector. A user of website 140 may select a desired language from a list of languages contained in language selector 150. Likewise, a desired currency may be selected from a currency list contained in the currency selector. Alternatively, information and prices on website 140 are displayed in the default language and currency of user 104. These defaults may be entered by agent 100 or user 104, retrieved from any active PNRs for the user, or determined from the user's departure location as set forth in any active PNRs.

In another embodiment with reference to FIG. 8, system 1 uses both historical data, as well as information contained in the active PNR for user 104, to determine what travel-related products are presented to the user. For example, assume data within the active PNR indicates user 104 is traveling to the United Kingdom during the summer. System 1 analyzes data contained in database servers 50 and GDS 44 corresponding to travel-related products previously purchased by other travelers in relation to the United Kingdom during the summer. System 1 then presents to user 104 either the same or similar products purchased most often by other travelers for the same destination and season as “most popular” items. System 1 also analyzes data contained in database servers 50 and GDS 44 corresponding to the travel-related products purchased specifically by user 104 in the past and presents similar products to the user. System 1 also optimizes the travel-related products presented to user 104 based on other information contained in the user's active PNR. For instance, system 1 offers user 104 certain travel-related products if the user is traveling first class, alone, during the winter, on a business trip, but offers certain other products if the user is traveling coach, with a family, during the summer, on vacation. Additionally, system 1 promotes other travel-related products based on other criteria. For example, if certain travel-related products are part of a distressed inventory, offer better commissions, or are promotional items, system 1 makes these items more noticeable when presenting them to user 104. User 104 is then able to purchase the optimized travel-related products in the same manner as described above. System 1 may also use the exact destination location to further tailor the travel-related products offered to the traveler. For example, if the PNR associated to the traveler includes information regarding a hotel (or any exact location that can be embodied by an address, a longitude and latitude coordinate, or a global positioning satellite coordinate), system 1 may interpret the hotel's location within a particular city as the destination. Any list of travel-related products offered may be further customized to display products and services, such as restaurants or attractions, that are within a predetermined or particular proximity to the hotel (such as walking distance).

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed:

1. A method for presenting travel-related products for use by a traveler comprising the steps of:
a. transmitting first data to a global distribution service, wherein said first data is capable of identifying said traveler;
b. based on said first data, accessing a record at said global distribution service corresponding to said traveler, wherein said record includes a destination and a corresponding date; and
c. based on said destination and said corresponding date contained in said record, automatically generating a list of corresponding travel-related products.

2. The method of claim 1 further comprising the step of reserving a first travel-related product by selecting said first travel-related product from said list.

3. The method of claim 1 wherein said destination is a connecting airport.

4. The method of claim 1 wherein said destination is a final destination.

5. The method of claim 2 further comprising the step of transmitting a first set of information to said global distribution service, said first set of information is representative of said reservation of said first travel-related product, wherein said global distribution service updates said record with said first set of information.

6. The method of claim 2 further comprising the step of receiving a confirmation of said reservation.

7. The method of claim 2 further comprising the step of transferring a payment for said first travel-related product to a provider of said first travel-related product.

8. The method of claim 2 further comprising the step of transferring a commission for said first travel-related product to an agent responsible for said reservation of said first travel-related product.

9. The method of claim 2 wherein said reserving said first travel-related product is performed by at least one user, wherein said user is selected from the group consisting of an agent and said traveler.

10. The method of claim 6 further comprising sending said confirmation of said reservation to said traveler.

11. The method of claim 10 wherein said confirmation includes a voucher.

12. The method of claim 10 wherein said sending is performed by an agent.

13. The method of claim 10 where said sending is performed automatically by an electronic device.

14. The method of claim 2 further comprising an agent accepting a payment by said traveler.

15. The method of claim 14 further comprising receiving a commission from said payment, wherein said commission is collected by said agent.

16. The method of claim 15 wherein said collection of said commission is concurrent with said acceptance of said payment.

17. The method of claim 15 further comprising transferring a difference of said commission and said payment to a third-party, wherein said third-party is selected from the group consisting of a provider of said first travel-related product and an aggregator of said first travel-related product.

18. A network of computers configured to present travel-related products for use by a traveler comprising:
a. a first computer maintained by a global distribution service, said first computer configured to maintain a record corresponding to said traveler, said record including a destination and a corresponding date;
b. a second computer including a memory, said second computer configured to maintain an inventory of said travel-related products on said memory; and
c. a third computer operatively connected to said first computer and said second computer; wherein
i. said first computer is configured to transmit first data to said third computer, said first data including said destination and said corresponding date of said record; and
ii. said third computer is configured to automatically request a first list of travel-related products from said second computer based on said destination and said corresponding date, said first list of travel-related products corresponding to said destination and said corresponding date.

19. The network of claim 18 wherein said third computer is configured to select a first travel-related product from said first list based on a user input.

20. The network of claim 19 wherein said third computer is configured to transmit second data to said first computer, said second data being representative of said selection.

21. The network of claim 20 wherein said first computer is configured to add at least a portion of said second data to said record.

22. The network of claim 19 wherein said third computer is configured to transmit second data to said second computer, said second data being representative of said selection.

23. The network of claim 22 wherein said second computer is configured to add at least a portion of said second data to said memory.

24. The network of claim 18 wherein said inventory is contained in a database on said memory.

25. The network of claim 19 wherein said third computer is configured to transmit a confirmation of said selection to said traveler.

26. The network of claim 19 wherein said third computer is configured to accept second data from a user, said second data being representative of a payment for said first travel-related product.

27. The network of claim 26 further comprising a fourth computer maintained by a financial intermediary, wherein said fourth computer is operatively connected to said third computer, said fourth computer being configured to receive said second data from said third computer.

28. The network of claim 26 wherein said third computer is configured to transmit said second data to said first computer.

29. The network of claim 26 wherein said third computer is configured to transmit said second data to said second computer.

30. The network of claim 18 further comprising:
a. a fourth computer maintained by a provider of said travel-related products, wherein said fourth computer includes a memory containing a second inventory of said travel-related products, said fourth computer being operatively connected to said second computer and said third computer;
b. wherein said second computer is configured to:
i. automatically request a second list of said travel-related products based on said destination and said corresponding date; and
ii. incorporate said second list into said first list.

31. The network of claim 30 wherein said third computer is configured to select a first travel-related product from said first list based on a user input.

32. The network of claim 31 wherein said third computer is configured to transmit second data to said first computer, said second data being representative of said selection.

33. The network of claim 32 wherein said first computer is configured to add at least a portion of said second data to said record.

34. The network of claim 31 wherein said third computer is configured to transmit second data to said second computer, said second data being representative of said selection.

35. The network of claim 34 wherein said second computer is configured to add at least a portion of said second data to said memory.

36. The network of claim 31 wherein said third computer is configured to transmit second data to said fourth computer, said second data being representative of said selection.

37. The network of claim 31, wherein said third computer is configured to:
a. accept second data from a user, wherein said second data is representative of a payment for said selection; and
b. transmit said second data to said fourth computer.

38. The network of claim 31 wherein said third computer is configured to transmit a confirmation of said selection to said traveler and to said fourth computer.

39. The network of claim 18 wherein said third computer is operated by said traveler.

40. The network of claim 30 wherein said third computer is operated by said traveler.

41. A method for reserving travel-related products for use by a traveler comprising the steps of:
a. extracting a destination and a corresponding date from a record maintained by a global distribution service, wherein said record corresponds to said user;
b. automatically requesting said travel-related products from a plurality of providers of said travel-related products, wherein said request is based on said destination and said corresponding date;
c. responsively generating a list of said plurality of travel-related products; and
d. reserving a first said travel-related product from said list for said traveler.

42. The method of claim 41 further comprising the step of adding information representative of said reservation to said record.

43. The method of claim 41 further comprising the step of transferring a payment to a first said provider, wherein said first provider offers said first travel-related product.

44. The method of claim 41 further comprising the step of sending a confirmation of said reservation to said traveler.

45. The method of claim 44 further comprising the step of accepting said confirmation in exchange for said first travel-related product.

46. The method of claim 45 further comprising the steps of:
a. validating said confirmation as a verification of said acceptance; and
b. transferring a payment to said first provider based on said validation.

47. The method of claim 41 wherein said automatic request includes selecting a subset of an inventory of travel-related products, said subset being defined by said destination and said corresponding date.

48. The method of claim 47 wherein said inventory is maintained in a database.

49. The method of claim 41 wherein said automatic request includes requesting a subset of an inventory maintained by said plurality of providers, said request being defined by said destination and said corresponding date.

50. A system for presenting travel-related products for use by a traveler comprising:
a. a record maintained by a global distribution service, wherein said record corresponds to said traveler and contains a destination and a corresponding date;
b. a first memory containing a first inventory of said travel-related products; and
c. a processor operatively connected to said global distribution service and in communication with said first memory, said processor configured to:
i. receive said destination and said corresponding date of said record from said global distribution service; and
ii. automatically request a first list of said travel-related products from said first inventory of travel said-related products based on said destination and said corresponding date.

51. The system of claim 50 wherein said first inventory of said travel-related products is maintained in a database on said first memory.

52. The system of claim 50 further comprising a second memory in communication with said processor and containing a second set of said travel-related products in communication with said processor, wherein said processor is configured to automatically request a second list of said travel-related products from said second set of said travel-related products based on said destination and said corresponding date.

53. The system of claim 52 where said second set of travel-related products is maintained in a catalog on said second memory.

54. The system of claim 50 wherein:
a. said processor is configured to:
i. select a first travel-related product from said first list based on an input from a user; and
ii. transmit first data to said global distribution service, wherein said first data is representative of said selection; and
b. wherein said global distribution service adds at least a portion of said first data to said record.

55. The system of claim 54 wherein said processor is configured to add said first data to said first memory.

56. The system of claim 52 wherein:
a. said processor is configured to:
i. incorporate said second list into said first list;
ii. select a first travel-related product from said first list based on an input from a user;
iii. transmit first data to said global distribution service, wherein said first data is representative of said selection; and
iv. add at least a first portion of said first data to said second memory; and
b. wherein said global distribution service adds at least a second portion of said data to said record.

57. The system of claim 52 wherein said processor communicates with said first memory and said second memory through the use of an application programming interface.

58. A method for presenting travel-related products for use by a traveler comprising the steps of:
a. generating a first list of said travel-related products corresponding to an input provided by a user, wherein said input includes at least a destination and a date;
b. purchasing a first said travel-related product from said first list, wherein said first travel-related product corresponds to said destination and said date;
c. creating a record maintained by a global distribution service, said record includes first data representative of said first purchase of said first travel-related product, wherein said first data includes said destination and said date;
d. extracting said destination and said date from said record; and
e. automatically generating a second list of said travel-related products based on said destination and said date from said record.

59. The method of claim 58 further comprising the steps of:
a. purchasing a second said travel-related product from said second list; and
b. adding second data to said record, wherein said second data is representative of said second purchase of said second travel-related product.

60. The method of claim 58 wherein the method is performed through the use of an application programming interface.

61. An inventory control system for managing an inventory of travel-related products offered by a provider for use by a traveler comprising:
a. an electronic network;
b. a first processor operatively connected to said network;
c. a memory in communication with said first processor, said memory capable of storing data representative of said inventory; and
d. a display operatively connected to said network;
e. wherein said first processor is configured to:
i. receive first data from said provider over said network, wherein said first data is representative of a first travel-related product;
ii. add said first data to said memory;
iii. transmit said first data to said display;
iv. receive second data representative of a payment information for purchase of said first travel-related product;
v. create a voucher corresponding to said payment information and to said first travel-related product, wherein said voucher contains a validation code; and
vi. transmit said voucher to said traveler.

62. The inventory control system of claim 61 wherein said display is remotely located relative to said first processor over said network.

63. The inventory control system of claim 61 further comprising an input operatively connected to said network, said input configured to accept said payment information from a user.

64. The inventory control system of claim 63 further comprising a second processor operatively connected to said network, said second processor configured to:
a. receive said payment information from said input; and
b. transmit said second data representative of said payment information to said first processor.

65. The inventory control system of claim 61 wherein said first processor is configured to:
a. receive third data representative of said validation code; and
b. verify said validation code.

66. The inventory control system of claim 65 wherein said first processor is configured to transmit fourth data representative of a payment to said provider for said first travel-related product based on said verification.

67. The inventory control system of claim 66 further comprising a second processor operatively connected to said network, said second processor configured to:
a. receive said fourth data from said first processor; and
b. apply said payment to said provider for said first travel-related product.

68. The inventory control system of claim 61 wherein said first processor is configured to:
a. receive third data representative of said first travel-related product, wherein said third data differs from said first data; and
b. update said first data on said memory with said second set of data.

69. A computer program embodied in a tangible medium, said computer program presenting travel-related products for use by a traveler, said computer program performing the following steps:
a. transmitting first data capable of identifying said traveler to a global distribution service;
b. receiving at least a portion of a record maintained by said global distribution service, said record corresponding to said traveler, wherein said portion includes a destination and a date; and
c. automatically generating a list of said travel-related products based on said destination and said date.

70. The computer program of claim 69 further performing the following steps:
a. automatically transmitting second data representative of said destination and said date to a provider upon receipt of said portion; and
b. receiving third data representative of at least one of said travel-related products offered by said provider, wherein said at least one travel-related product corresponds to said destination and said date.

71. The computer program of claim 70 further performing the following steps:
a. displaying said list; and
b. accepting a selection of an item of said list.

72. The computer program of claim 71 further performing the following step:
a. transmitting fourth data representative of said selection, wherein said fourth data also includes data capable of identifying said traveler.

73. The computer program of claim 71 further performing the following step:
a. updating said record to include fourth data representative of said selection.

74. The computer program of claim 69 wherein the steps are performed through the use of an application programming interface.
